(19) United States
(12) Patent Application Publication
(10) Pub. No.: US 2007/0290612 A1
(43) Pub. Date: Dec. 20, 2007

(54) Light Emitting Device and Method for Producing Same

(75) Inventors: Toshio Hama, Nagano (JP); Koji Kawaguchi, Nagano (JP); Makoto Kobayashi, Nagano (JP); Kenya Sakurai, Nagano (JP)

Correspondence Address: ROSSI, KIMMS & McDOWELL LLP., P.O. BOX 826, ASHBURN, VA, 20146-0826, US

(73) Assignee: FUJI ELECTRIC HOLDING CO., LTD., Kawasaki-ku, Kawasaki (JP)

(21) Appl. No.: 11/574,497

(22) PCT Filed: Sep. 6, 2005
(86) PCT No.: PCT/JP05/16330

§ 371 Date: Apr. 10, 2007

(30) Foreign Application Priority Data
Sep. 7, 2004 (JP) 2004-260211

(51) Int. Cl. H05B 33/00; H05B 33/10

(52) U.S. Cl. 313/506; 427/66

(57) ABSTRACT

[Problems] To provide a white or multicolor light emitting device that sufficiently contains components of various wavelength regions while having excellent brightness balance among the colors, and a method for producing such a light emitting device by a simple process.

[Means to Solve the Problems] A light emitting device comprising, on a transparent substrate, a complementary color layer, a transparent electrode, an organic light emitting body and a reflective electrode. This light emitting device is characterized in that the organic light emitting body comprises at least a blue light emitting layer and a red light emitting layer, the complementary color layer absorbs a part of the light emitted from the organic light emitting body and emits green light, and the device emits white light from the transparent substrate side.

### TECHNICAL FIELD

The present invention relates to a white or multicolor light emitting device that exhibits high definition and good visibility, and allows extensive applications. The invention also relates to a method for producing such a device. The light emitting device can be applied to displays in personal computers, word processors, televisions, audio sets, video recorders, car navigations, telephones, mobile terminals, and industrial instruments.

### BACKGROUND ART

An example of known light emitting devices applied to display devices is an electroluminescence device. An electroluminescence device is a thin film self light emitting device and has excellent characteristics of a low driving voltage, high resolution, and a wide view angle. Consequently, extensive studies have been made for practical applications thereof.

There have been proposed methods for full color display using the electroluminescence devices: “a patterned RGB method”, in which device elements are arranged emitting red, green and blue colors upon application of electric field; “a color filter method”, in which red, green and blue colors are obtained by transmitting white color light through color filters that transmit the light in specific wavelength region; and “a color conversion method” that uses a filter containing color conversion material(s) that absorbs near ultraviolet light, blue light, blue-green light, or white light, and converting wavelength distribution, emits light in the visible region.

Among these methods, the color filter method allows use of a monochromatic electroluminescence device and needs less production steps than the color conversion method, and thus, is considered favorable for producing a large area display.

The color filter method as described above is a method to obtain desired colors such as red, green and blue colors using color filters that transmit only necessary wavelength components from the white light emitted from an electroluminescence device. Consequently, the light emitted by the electroluminescence device needs to include components of wavelengths of red, green, and blue colors in a proper balance.

Techniques have been proposed for obtaining white light emission in an electroluminescence device: (1) A technique of using a white light emitting material (Non-patent Document 1); (2) A technique of mixing plural light emitting materials for RGB or complementary colors (Non-patent Document 2); and (3) A technique of laminating plural layers of light emitting materials for RGB or complementary colors. This third technique uses for example, three light emitting layers that bear distinct carrier transport characteristics and emit blue, green and red colors (Non-patent Document 3), or laminates a layer of red color light emission and electron transport on a layer of blue light emission including a host material of aluminum chelate that has mixed ligands (Patent document 1). However, in the technique of (1), such a white light emitting material has not been found that emits perfect white light, withstands long time driving, and exhibits stable and highly effective emission. The techniques of (2) and (3) confront serious problems in practical application, namely, necessity to exactly control the balance between light emissions from the light emitting materials used, and tendency of variation of the balance between light emissions in the case of change of brightness or in continuous driving.

Another electroluminescence device has been proposed (Patent document 2) in which a blue light emitting layer and a green light emitting layer are sequentially laminated and the green light emitting layer includes a portion that contains red color dye. The green light emitting layer in this structure is made of an aluminum chelate functioning electron transport or made by doping a green color dye in the chelate. A red light emitting region is the region doped with the red color dye in the aluminum chelate. This structure still remains the problems of necessity to exactly control the balance between light emissions (brightness) and the tendency of variation of the balance in continuous driving.

In yet another proposal (Patent document 3), a light emitting layer is a laminate of a blue light emitting layer/a green light emitting layer and a red color dye is doped in one of the other layers of the electroluminescence device. In this structure, a green light emitting layer is formed of aluminum chelate. This structure has a drawback in that when a red light emitting dopant is mixed in the green light emitting layer, light emission by the dopant becomes dominant; when the content of dopant is decreased, desired white light cannot be obtained.

Patent Document 4 proposes to obtain white light emission having a flat emission spectrum with respect to wavelength by providing a light emitting layer containing a host material that emits principal color light and a dopant that emits complementary color light, and by comprising a wavelength conversion substance of stylbene compound that absorbs the light from the host and emits light with longer wavelength. However, only several percent of the contained dopant dominates the light emission from the dopant. Therefore, there still remain the problems of necessity to exactly control the balance between light emitting dopants and color conversion substance, and the tendency of variation of the balance between light emissions in continuous driving.

Patent Document 5 proposes a structure comprising a light emitting layer composed by laminating a blue light emitting organic material in the anode side and an orange light emitting organic material in the cathode side so as to inhibit absorption of blue color light by the orange light emitting organic material. The structure still has the problems of necessity to exactly control the balance between light emissions from the light emitting materials, and the tendency of variation of the balance between light emissions in the case of change of brightness or in continuous driving.

Patent Document 1: Japanese Unexamined Patent Application Publication No. H7-150139

Patent Document 2: Japanese Unexamined Patent Application Publication No. H7-142169

Patent Document 3: Japanese Unexamined Patent Application Publication No. H6-207170

Patent Document 4: Japanese Unexamined Patent Application Publication No. 2000

Patent Document 5: Japanese Unexamined Patent Application Publication No. 2000

Patent Document 6: Japanese Unexamined Patent Application Publication No. H5-134112

Patent Document 7: Japanese Unexamined Patent Application Publication No. H7-218717

Patent Document 8: Japanese Unexamined Patent Application Publication No. H7-306311

Patent Document 9: Japanese Unexamined Patent Application Publication No. H5-119306

Patent Document 10: Japanese Unexamined Patent Application Publication No. H7

Patent Document 11: Japanese Unexamined Patent Application Publication No. H6

Patent Document 12: Japanese Unexamined Patent Application Publication No. H7

Patent Document 13: Japanese Unexamined Patent Application Publication No. H8

Patent Document 14: Japanese Unexamined Patent Application Publication No. H9

Patent Document 15: Japanese Unexamined Patent Application Publication No. H8-27934

Patent Document 16: Japanese Unexamined Patent Application Publication No. H5-36475

Non-patent Document 1: T. Ogura et al., Extended Abstract of the 38th Spring Meeting of the Japan Society of Applied Physics and Related Societies, No. 31 p-G-13 (1991) (in Japanese)

Non-patent Document 2: Appl. Phys. Lett., 64, 815 (1994)

Non-patent Document 3: Extended Abstracts of the 55th Autumn Meeting of the Japan Society of Applied Physics, No. 19p-H-6 (1994) (in Japanese)

Non-patent Document 4: “Gekkan Display” (“Monthly Display”, in Japanese), Vol. 3, No. 7 (1997)

### DISCLOSURE OF THE INVENTION

### Problem to Be Solved by the Invention

It is therefore an object of the present invention to provide a sub-structure of an electroluminescence element and a white or multicolor light emitting device including the element which gives ideal white light emission containing all of the three wavelength regions of red, green and blue colors in a proper balance, and prevents variation of balance of light emission even in the cases of brightness change and continuous driving.

### Means for Solving the Problem

A light emitting device of the first aspect of embodiment of the invention comprises a complementary color layer, a transparent electrode, an organic light emitting body, and a reflective electrode formed over a transparent substrate. This light emitting device is characterized in that the organic light emitting body comprises at least a blue light emitting layer and a red light emitting layer; the complementary color layer absorbs a part of the light emitted from the organic light emitting body and emits green light; and the device emits white light from the transparent substrate side. The light emitting device can further comprise at least three types of color filters independently arranged between the transparent substrate and the complementary color layer to emit multicolor light through the transparent substrate. The complementary color layer can function as a protective layer for the color filters. The transparent electrode can be composed of a plurality of electrode elements of stripe shape extending in a first direction and the reflective electrode is composed of a plurality of electrode elements of stripe shape extending in a first direction, the first direction crossing the second direction to perform matrix driving. Alternatively, the matrix driving can be performed by a structure in which the transparent electrode is formed in a single piece and the reflective electrode is composed of a plurality of electrode elements each connecting to each of plural switching elements in one-to-one corresponding manner. A complementary color layer of this aspect of embodiment preferably includes a matrix material and at least one color conversion material dispersed in the matrix material.

A light emitting device of the first aspect of embodiment can be produced by a method characterized in that the method comprises a step of preparing a transparent substrate, a step of providing a complementary color layer, a step of providing a transparent electrode, a step of providing an organic light emitting body, and a step of providing a reflective electrode. The method can further comprise a step of providing at least three types of independent color filters before the step of providing the complementary color layer. The method can further comprise a step of providing a gas barrier layer before the step of providing the transparent electrode.

A light emitting device of the second aspect of embodiment of the invention is characterized in that the light emitting device comprises a filter laminate and an organic light emitting element, the filter laminate including at least a complementary color layer formed over a transparent substrate, and the organic light emitting element including a reflective electrode, an organic light emitting body, and a transparent electrode formed on a device substrate in this order. The filter laminate and the organic light emitting element are bonded together so that the complementary color layer and the transparent electrode are opposed with each other. White light is emitted from the transparent substrate side. The light emitting device can further comprise at least three types of color filters independently arranged between the transparent substrate and the complementary color layer to emit multicolor light from the transparent substrate side. The complementary color layer can further function as a protective layer for the color filters. The transparent electrode can be composed of a plurality of electrode elements of stripe shape extending in a first direction and the reflective electrode is composed of a plurality of electrode elements of stripe shape extending in a first direction, the first direction crossing the second direction to perform matrix driving. Alternatively, the matrix driving can be performed by a structure in which the transparent electrode is formed in a single piece and the reflective electrode is composed of a plurality of electrode elements each connecting to each of plural switching elements in one-to-one corresponding manner. A complementary color layer of this aspect of embodiment preferably includes a matrix material and at least one color conversion material dispersed in the matrix material.

The light emitting device of the second aspect of embodiment can be produced by a method characterized in that the method comprises a step of preparing a transparent substrate, a step of forming a filter laminate by providing a complementary color layer over the transparent substrate, a step of preparing a device substrate, a step of providing a reflective electrode on the device substrate, a step of providing an organic light emitting body on the reflective electrode, a step of obtaining an organic light emitting element by providing a transparent electrode on the organic light emitting body, and a step of bonding the filter laminate and the organic light emitting element together so that the complementary color layer and the transparent electrode opposes each other. The method can further comprise a step of providing at least independent three types of color filters before providing the complementary color layer. The method can comprises a step of providing a gas barrier layer after providing the complementary color layer.

### Effect of the Invention

The constitution of the invention as described above can produce, in a simple process, a light emitting device emitting white light including sufficient components of wavelength regions in an excellent brightness balance between colors, and a multicolor light emitting device using the white light emitting device together with color filter layers. In a conventional device of poor brightness balance, a portion corresponding to the color of low brightness is forced to light intensely to maintain the brightness balance. As a result, the lifetime of a portion corresponding to each color differs from each other. So, the shift of color tone becomes significant in a long term driving. In addition, precise control is needed for every portion corresponding to each color, which requires a complicated driving circuit, causing cost increase. Therefore, a light emitting device according to the invention that performs excellent brightness balance brings about favorable effects in both lifetime and costs.

### BRIEF DESCRIPTION OF THE DRAWINGS

FIG. 1 is a schematic sectional view showing an example of a structure of a multicolor light emitting device of a first aspect of embodiment according to the invention; and

FIG. 2 is a schematic sectional view showing an example of a structure of a multicolor light emitting device of a second aspect of embodiment according to the invention.

### EXPLANATION OF LETTERS OR NUMERALS

1: transparent substrate
2: black matrix
3: red color filter
4: green color filter
5: blue color filter
6: complementary color layer
7: gas barrier layer
8: transparent electrode
9: organic light emitting body
10: reflective electrode
11: device substrate
12: adhesion/peripheral sealing layer

### BEST MODE FOR CARRYING OUT THE INVENTION

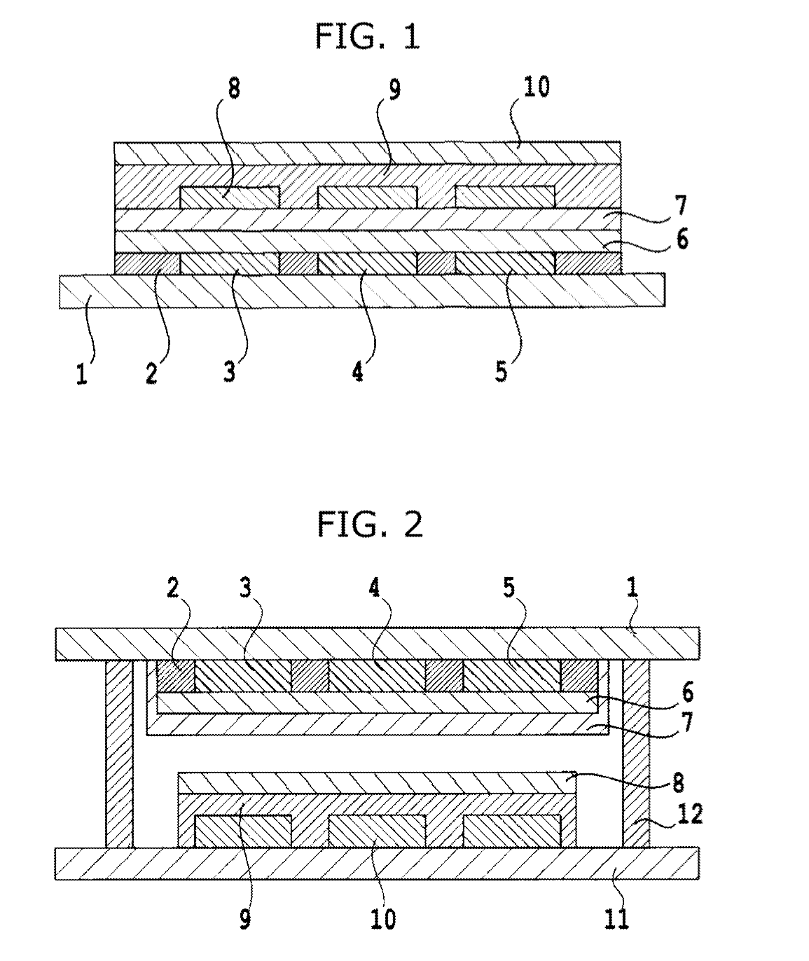

FIG. 1 is a schematic sectional view of a multicolor light emitting device of the first aspect of embodiment according to the invention. In the multicolor light emitting device of this aspect of embodiment, laminated on a transparent substrate 1 are a black matrix 2, color filters (red color: 3, green color: 4, and blue color: 5), a complementary color layer 6, a gas barrier layer 7, a transparent electrode 8, an organic light emitting body 9, and a reflective electrode 10. The black matrix 2 and the gas barrier layer 7 can be optionally provided, but is desired to be provided. Each construction elements will be described in the following.

1. Transparent substrate 1

A transparent substrate 1 in FIG. 1 only needs good transparency to the visible light and is required not to cause degradation of the multicolor light emitting device in the process of forming the multicolor light emitting device. The transparent substrate 1 can be formed of a glass substrate, various plastic substrates, or various kinds of films.

2. Color filter and black matrix

Color filters (3, 4, and 5) in a multicolor light emitting device of the invention transmit the components of desired wavelength regions of the light that is transmitted through the complementary color layer 6. A single color filter or plural types of color filters can be provided. The color filters can be those used for flat panel displays such as liquid crystal displays. Widely used these days are pigment-dispersed type color filters, which contain pigment dispersed in photoresist material.

Each of the color filters 3, 4, and 5 shown in FIG. 1 has a transmission region in a wavelength region different from each other. For example, the color filter 3 is a red color filter transmitting light in the red color region (in the wavelength region longer than 600 nm), the color filter 4 is a green color filter transmitting light in the green color region (in the wavelength region from 500 to 600 nm), and the color filter 6 is a blue color filter transmitting light in the blue color region (in the wavelength region from 400 to 550 nm).

The color filters of a light emitting device used in a display device are disposed corresponding to the positions of pixels or subpixels that are determined by the arrangement of electrode elements as described later. Black matrixes 2 that do not transmit visible light are generally arranged in the gaps between pixels or subpixels of the color filters. The black matrix 2 is effective for improving contrast of a multicolor light emitting device. Black matrix 2 in the invention, as well as a color filter, can be formed of a commercially available material for use in a flat panel display.

3. Complementary color layer 6

A complementary color layer in the invention is provided to convert wavelength distribution of a part of the light emitted from an organic light emitting body and to obtain white light containing sufficient components of three wavelength regions of red, green and blue colors, in addition to the purposes of protecting a color filter and smoothing a surface of the color filter. A complementary color layer 6 includes a matrix material and color conversion material dispersed in the matrix material.

(a) Matrix

Matrix of a complementary color layer 6 is formed of a material that has good transparency and is able to be fabricated by a process avoiding deterioration of the color filters. On the complementary color layer 6, a gas barrier layer and a light emitting element including electrodes and an organic light emitting body are formed, so the complementary color layer is also required to exhibit resistance against sputtering.

A complementary color layer 6, intending also for smoothing the film surface, is generally formed by means of coating. Applicable materials include photo-setting resins and optically and thermally curable resins. After coating, such a material is generally optically and/or thermally treated to generate radical species or ion species, and polymerized or cross-linked to get an insoluble and infusible matrix. When the complementary color layer 6 needs patterning by photolithography, the photo-setting resin or optically and thermally curable resin is desired soluble in an organic solvent or an alkali solvent at the uncured stage.

Specific cured materials of photo-setting resins or optically and thermally curable resins that can be used for a matrix include: (1) a material made by optically or thermally treating a film of a composition consisting of an acrylic multi-functional monomer or oligomer having a plurality of acroyl groups or methacroyl groups, and an optical or thermal polymerization initiator to generate photo-radicals or thermo-radicals and polymerize the monomer or oligomer; (2) a material made by optically or thermally treating a composition consisting of poly(vinyl cinnamate) and a photo-sensitizer to dimerize and crosslink; (3) a material made by optically or thermally treating a film of a composition consisting of direct chain or cyclic olefin and bisazide to generate nitrene and cross-link with the olefin; and (4) a material made by optically or thermally treating a film of a composition consisting of monomer with an epoxy group and photoacid generators to generate acid (cations) and polymerize the monomer. Among these materials, the material of (1), a mixture of acrylic multi-functional monomer or oligomer and the initiator, is preferable in particular because of capability of high definition patterning and from the view point of reliability including solvent resistance and heat resistance.

A matrix of the complementary color layer 6 can also be made of a thermo-plastic resin selected from polycarbonate (PC), poly(ethylene terephthalate) (PET), polyether sulfone, poly(vinyl butyral), polyphenylene ether, polyamide, polyether imide, norbornene resin, acrylic resin, methacrylic resin, isobutylene-maleinic anhydride copolymer resin, and cyclic olefin resin; a thermo-setting resin selected from epoxy resin, phenolic resin, urethane resin, vinyl ester resin, imide resin, urethane resin, urea resin, and melamine resin; or a polymer hybrid formed of a polymer selected from polystylene, polyacrylonitrile and polycarbonate, and a compound of alkoxy silane with three or four functional groups.

A thickness of the complementary color layer 6 is an important factor. A too thick complementary color layer deteriorates view angle performance. When a display is seen from an oblique angle, the light from neighboring pixels or subpixels transmits out and it looks like lighting despite non-lighting state. A thickness of the complementary color layer 6 is preferably in the range of 3 to 15 μm, more preferably in the range of 5 to 10 μm on the top surface of the color filters. A thickness in such a range can make the light from the organic light emitting body white, and at the same time, keeps good view angle performance.

(b) Color conversion material

Color conversion material contained in the complementary color layer 6 transmits a part of the light from the organic light emitting body, and absorbs another part of the light and emits light with a wavelength different from the wavelength of absorbed light. When light including blue color and red color components is emitted from the organic light emitting body depending on the structure of the organic light emitting body, the color conversion material is preferably a green color conversion material that absorbs light of the blue color component and emits light with a green color component. A color conversion material in the invention can be an inorganic or organic material that absorbs light in blue color (400 to 500 nm) and emits light of fluorescence or phosphorescence in green color.

Specific green color conversion material can be selected from, for example, coumarin dyes such as 3-(2′-benzothiazolyl)-7-diethylamino-coumarin (coumarin 6), 3-(2′-benzoimidazolyl)-7-N,N-diethylamino-coumarin (coumarin 7), 3-(2′-N-methyl-benzoimidazolyl)-7-N,N-diethylamino-coumarin (coumarin 30), and 2,3,5,6-1H,4H-tetrahydro-8-trifluoromethyl-quinolidino (9,9a, 1-gh) coumarin (coumarin 153); coumarin derivatives such as basic yellow 51; and naphthalimide dyes such as solvent yellow 11 and solvent yellow 116. A variety of dyes including direct dye, acid dye, basic dye, and disperse dye can be used as far as it has absorption characteristic and fluorescence in an appropriate wavelength region.

In an especially favorable embodiment of the invention, the light from an organic light emitting body contains two components of wavelength, a blue color component and a red color component, and a part of the light is converted into green color, obtaining, as a whole, white color light containing three wavelength regions. Consequently, the type and the amount of the color conversion material in the complementary color layer cannot be commonly determined, but depend greatly on the emission spectrum of the organic light emitting body, the absorption/fluorescence spectrum of the specific color conversion material, and the thickness of the complementary color layer 6. Nevertheless, it is possible to adjust the balance between the portion of the light emitted from the organic light emitting body and transmitted through the complementary color layer 6 and the portion of the light emitted from the complementary color layer in order to obtain an aimed white light spectrum.

4. Gas barrier layer 7

A gas barrier layer 7 is provided for the purpose of preventing the organic light emitting body from deterioration caused by moisture and/or oxygen originated in the layers formed under the organic light emitting body and arriving at the organic light emitting body. The gas barrier layer 7 is formed of a material that is highly transparent in the visible light region (transmittance of more than 50% in the wavelength range of 400 to 700 nm), has a glass transition temperature (Tg) of higher than 100° C., exhibits a film hardness of pencil hardness of 2H or more, and does not degrade the functions of the color filters and the complementary color layer 6. Such a material can be selected from imide-modified silicone resin (Patent Documents 6 through 8), materials containing inorganic metal compound (TiO, Al₂O₃, SiO₂ or the like) dispersed in acrylic resin, polyimide resin, silicone resin, or the like (Patent Documents 9 and 10), a resin having reactive vinyl groups of acrylate monomer/oligomer/polymer, a resist resin (Patent Documents 11 through 14), inorganic compounds formed by a sol-gel method (Non-patent Document 4 and Patent Document 15), photo-setting and/or thermo-setting resins such as fluorine-containing resins (Patent Documents 14 and 16). A gas barrier layer can be formed using one of these materials by an appropriate method without any special limitation. A method for forming a gas barrier layer can be selected from commonly used methods of dry methods (a sputtering method, an evaporation method, a CVD method and the like) and wet methods (a spin-coating method, a roll-coating method, a casting method and the like).

Alternatively, a gas barrier layer 7 can be formed of a material that exhibits electric insulative property, a barrier characteristic against gases and organic solvents, high transparency in visible light region (transmissivity of more than 50% in a wavelength range of 400 to 800 nm), and a film hardness of preferably pencil hardness 2H or harder, which withstands the conditions for depositing electrodes formed thereon. Such materials include inorganic oxides and nitrides such as SiOₓ, SiNₓ, SiNₓO_{y}, AlOₓ, TiOₓ, TaOₓ, and ZnOₓ. These materials can be used for forming a gas barrier layer 7 without any special limitation, and allow employing a commonly used method of a sputtering method, a CVD method, a vacuum evaporation method, a dip-coating method, a sol-gel method, or the like.

A gas barrier layer 7 can be a single layer formed of the materials mentioned above, or a laminated structure of a plurality of layers formed of the materials.

When a gas barrier layer 7 is provided in a multicolor light emitting device of this aspect of embodiment, the effect on the view angle characteristic must be taken into consideration as in the case of a complementary color layer 6. A too thick gas barrier layer 7 elongates the optical pass of the light emitted from an organic light emitting body in the passage through the gas barrier layer 7 until reaching a complementary color layer or color filters. As a result, when the multicolor light emitting device is seen from an oblique angle, light leakage to neighboring pixels or subpixels of different color (optical crosstalk) occurs. Consideration on the display performance of a multicolor light emitting device requires a minimum ratio of light emission from the neighboring pixels or subpixels due to the optical crosstalk to light emission from the primary pixels or subpixels. Taking this point into account, a thickness of a gas barrier layer 7 (in the case of a laminate of plural layers, the sum of the thicknesses) is preferably in the range of 0.1 to 5 μm.

5. Electrodes

A transparent electrode 8 is formed by laminating a conductive metal oxide such as SnO₂, In₂O₃, ITO, IZO, or ZnO:Al by means of a sputtering method. The transparent electrode 8 has preferably a transmissivity of more than 50%, more preferably more than 85% to light in the wavelength range of 400 to 800 nm. The transparent electrode 8 preferably has a thickness of more than 50 nm, more preferably in the range of 50 nm to 1 μm, most preferably in the range of 100 to 300 nm.

A reflective electrode 10 is preferably formed by using a high reflectivity metal, a high reflectivity amorphous alloy, or a high reflectivity microcrystalline alloy. The high reflectivity metal can be selected from Al, Ag, Mo, W, Ni, and Cr. The high reflectivity amorphous alloy can be selected from NiP, NiB, CrP, and CrB. The high reflectivity microcrystalline alloy can be NiAl, for example. An alloy containing the high reflectivity metal mentioned above (Mg/Ag alloy, for example) can be used, too. The reflective electrode 10 can be formed by any appropriated method such as evaporation method, sputtering method, or the like known in the art.

In the invention, one of the transparent electrode 8 and the reflective electrode 10 can be used as an anode and the other is used as a cathode. Preferably, a transparent electrode 8 is used as an anode and a reflective electrode 10 is used as a cathode. Each of the transparent electrode 8 and the reflective electrode 10 can be composed of a plurality of electrode elements having a stripe shape to conduct passive matrix driving. In this case, the direction in which the stripe shape electrode elements of the transparent electrode 8 extends crosses, preferably orthogonally, the direction in which the stripe shape electrode elements of the reflective electrode 10 extends. Active matrix driving is also possible by separately providing a plurality of switching elements (TFT, for example) and composing the reflective electrode 10 of a plurality of electrode elements each connecting to each of the switching elements in one-to-one corresponding manner. The transparent electrode 8 in this case is formed as a single electrode of one piece.

6. Organic light emitting body

An organic light emitting body 9 is sandwiched by the transparent electrode 8 and the reflective electrode 10, and comprises at least an organic light emitting layer. The organic light emitting body can further comprise, as necessary, a hole injection layer, a hole transport layer, an electron transport layer, and/or an electron injection layer. A specific layer structure selected from the following can be employed.

(1) Anode/Organic light emitting layer/Cathode

(2) Anode/Hole injection layer/Organic light emitting layer/Cathode

(3) Anode/Organic light emitting layer/Electron transport layer/Cathode

(4) Anode/Organic light emitting layer/Electron transport layer/Electron injection layer/Cathode

(5) Anode/Hole injection layer/Organic light emitting layer/Electron transport layer/Cathode

(6) Anode/Hole injection layer/Hole transport layer/Organic light emitting layer/Electron injection layer/Cathode

(7) Anode/Hole injection layer/Hole transport layer/Organic light emitting layer/Electron transport layer/Cathode

(8) Anode/Hole injection layer/Hole transport layer/Organic light emitting layer/Electron transport layer/Electron injection layer/Cathode

In the structures of (1) through (8), the anode is preferably a transparent electrode 8 and the cathode is preferably a reflective electrode 10.

A material of the hole injection layer can be selected from phthalocyanines (Pcs) (including copper phthalocyanine (CuPc)) and indanthrene compounds.

A hole transport layer can be formed of a material having a triaryl amine partial structure, a carbazole partial structure, or an oxadiazole partial structure, for example, TPD, α-NPD, PBD, and m-MTDATA.

Useful materials for an electron injection layer includes alkali metals such as Li, Na, K, and Cs, alkaline earth metals such as Ba and Sr, alloys including these metals, rare earth metals, and fluorides of these metals, though not limited to these materials. In a structure of the invention, an electron injection layer is preferably provided in the organic light emitting body from the view point of improving electron injection efficiency. Thickness of an electron injection layer can be appropriately set considering the driving voltage and transparency, and preferably not larger than 10 nm in normal cases. The electron injection layer can also be formed using aluminum quinolinol complex doped with alkali metal or alkaline earth metal.

A material for the electron transport layer can be selected from oxadiazole derivatives such as PBD and TPOB, triazole derivatives such as TAZ; triazine derivatives; phenylquinoxalines; thiophene derivatives such as BMB-2T and BMB-3T; and aluminum complex such as aluminum tris(8-quinolinolate) Alq₃.

An organic light emitting layer in the invention consists of two layers, a blue light emitting layer and a red light emitting layer. A part of the light emitted from the blue light emitting layer of the two layers is converted into green color light in the complementary color layer 6, to produce white color light containing sufficient components in the three wavelength regions of red, green and blue colors. In the present invention, each of the blue and red light emitting layers is preferably composed of a host-dopant system, which consists of host material and a dopant material doped in the host material. The host materials of the blue and red light emitting layers can be one common material. This constitution is favorable for simplification of the manufacturing process.

Useful host materials include aluminum chelate complex, 4,4′-bis(2,2-diphenylvinyl) biphenyl (DPVBi) and 2,5-bis(5-tert-butyl-2-bonzoxazolyl)thiophene (BBOT). Blue light emitting dopants useful in the blue light emitting layer include perylene, 2,5,8,11-tetra-tert-butyl-perylene (TBP), and 4.4′-bis[2-{4-(N,N-diphenylamino)phenyl} vinyl]biphenyl (DPAVBi). The blue light emitting dopant is contained in an amount of 0.1 to 5 wt % with respect to the total weight of the blue light emitting layer. Red light emitting dopants useful in the red light emitting layer include 4-dicyanomethylene pyran compounds such as 4-(dicyanomethylene)-2-methyl-6-(p-dimethylamino styryl)-4H-pyran (DCM1), 4-(dicyanomethylene)-2-methyl-6-(julolidin-4-yl-vinyl)-4H-pyran (DCM2), [2-(2-propyl)-6-[2-(2,3,6,7-tetrahydro-2,2,7,7-tetramethyl-1H,5H-benzo[ij]quinolizine-9-yl)-ethenyl]-4H-pyran-4-ylidene]-propane dinitrile (DCJT1); 4,4-difluoro-1,3,5,7-tetraphenyl-4-bora-3a,4a-diaza-s-indacene; and nile red. The red light emitting dopant is contained in an amount of 0.1 to 5 wt % with respect to the total weight of the red light emitting layer.

If the amount of red dopant is increased to enhance intensity of the red light component, intensity of the blue light component decreases. The converse is also true. When white light is to be obtained using a blue light emitting layer and a red light emitting layer through color conversion in the complementary color layer, an amount of added red color dopant is preferably in the range of one to two times amount of added blue color dopant.

In the organic light emitting layer of the invention, either of the blue light emitting layer or the red light emitting layer can be at the anode side. In order to improve the effect of electron-hole recombination, the thickness of the light emitting layer at the side of the junction interface (anode side) is preferably larger than the thickness of the light emitting layer at the side of cathode.

When the structure of a light emitting body includes the laminate of hole transport layer/blue light emitting layer/red light emitting layer/electron transport layer, a blue color dopant can be added into the host material of the hole transport layer to form a blue light emitting layer, and a red color dopant can be added into the host material of the electron transport layer to form a red light emitting layer.

FIG. 2 shows a sectional view of a multicolor light emitting device of the second aspect of embodiment of the present invention. A multicolor light emitting device of this embodiment comprises a filter laminate including the gas barrier layer 7 and the structures thereunder in the first aspect of embodiment, and an organic light emitting element including a reflective electrode 10, an organic light emitting body 9, and a transparent electrode 8 laminated on a device substrate 11 in this order. The filter laminate and the organic light emitting element are bonded together disposing the reflective electrode 10 and the complementary color layer 6 (or a gas barrier layer 7 when provided) opposing each other. The bonding can be carried out using an adhesion/peripheral sealing layer 12.

In the structure of this aspect of embodiment, the similar components as in the first aspect of embodiment can be used for the components of the filter laminate: transparent substrate 1, a black matrix 2, color filters (red: 3, green: 4, blue: 5), a complementary color layer 6, and a gas barrier layer 7. In this aspect of embodiment too, a black matrix 2 and a gas barrier layer 7 can be optionally provided, but, is preferably provided.

A device substrate 11 useful in this aspect of embodiment can be an insulative substrate made of glass or plastics, or a semiconductive substrate or a conductive substrate with an insulative thin film formed thereon. Alternatively, the device substrate 11 can be a flexible film made of polyolefin, acrylic resin, polyester resin or polyimide resin. In the case of active matrix driving, switching elements such as TFTs are provided on the device substrate 11.

An organic light emitting element in this aspect of embodiment can have a similar structure as the laminate of a transparent electrode 8/an organic light emitting body 9/a reflective electrode 10 in the first aspect of embodiment except that the lamination sequence is changed to a reflective electrode 10/an organic light emitting body 9/a transparent electrode 8. Every layer can be the same as in the first aspect of embodiment. The organic light emitting elements in this aspect of embodiment can be constructed to perform the passive matrix driving as in the first aspect of embodiment. However, the active matrix driving is advantageous in this aspect of embodiment, in particular, because the light emission from the organic light emitting body 9 need not to be extracted through the device substrate 11, so the light is not intercepted by the switching elements provided on the device substrate 11.

In the present aspect of embodiment, the bonding between the filter laminate and the organic light emitting element can be carried out using an adhesion/peripheral sealing layer 12. The adhesion/peripheral sealing layer 12 can be formed using an ultraviolet light-setting type adhesive, for example. The adhesion/peripheral sealing layer 12 can contain spacer of glass beads or silica beads with a diameter in the range of 20 to 60 μm, preferably in the range of 35 to 50 μm. The spacer sets the distance between the bonded filter laminate and organic light emitting element, and bears the pressure exerted for bonding. The bonding can be carried out by applying a material for the adhesion/peripheral sealing layer 12, which can be an ultraviolet light-setting type adhesive, around the periphery of the filter laminate or the organic light emitting element, then arranging a complementary color layer 6 or a gas barrier layer 7 (if provided) of the filter laminate and a transparent electrode 8 of the organic light emitting element opposing each other, and finally curing the material for the adhesion/peripheral sealing layer 12.

In a conventional white light emitting device having a blue light emitting layer and a red light emitting layer, intensity of light emission in the green color region cannot be sufficient. As a result, in operation as a display device, electric current supply must be increased in order to enhance the brightness at the locations corresponding to green color subpixels. The increased current accelerates degradation in those locations. If an orange color light emitting layer is used in place of the red color light emitting layer for the purpose of increasing the component in green color region, color purity of the red color degrades. In contrast to these white light emitting devices of the conventional technology, the light emitting devices of the first and second aspects of embodiment can compensate for the intensity in the green color region by color conversion in the complementary color layer 6. Therefore, the balance among red, green, and blue components can be kept favorable, and the local degradation of light emitting body in the driving operation can be avoided.

Since the complementary color layer 6 serves for a protective layer for a color filter, too, a light emitting device of the first and second aspects of embodiment of the invention can be produced by modifying and applying a conventional color filter type device without increasing the steps in the production process. The complementary color layer 6, being a layer including at least one type of color conversion material dispersed in a matrix, can be formed by a known simple wet process.

### EXAMPLES

The present invention will be further described with reference to some specific examples. The invention, however, shall not be limited to the description of the examples.

### Example 1

Coumarin 6 (0.7 parts by weight), a fluorescent dye, was dissolved in a solvent of 120 parts by weight of propylene glycol monoethyl acetate (PEGMA). Into this solution, 100 parts by weight of photo-polymerizing resin V259PA/P5 (a product of Nippon Steel Chemical Co., Ltd.) was added and dissolved to obtain a coating liquid. This coating liquid was applied on a transparent glass substrate by means of a spin-coating method to obtain a complementary color layer having a thickness of 2 μm.

On this complementary color layer, SiO₂ was deposited to a film thickness of 0.5 μm by means of a sputtering method to form a gas barrier layer. The sputtering apparatus used was an RF-planar magnetron type, and the target was SiO₂. The sputtering gas was argon and the substrate temperature in the deposition process was set at 80° C. Then, electrodes and an organic light emitting body were formed in a structure of anode (transparent electrode)/hole injection layer/hole transport layer/organic light emitting layer (red light emitting layer/blue light emitting layer)/electron transport layer/cathode (reflective electrode).

Over the whole surface of the gas barrier layer, ITO was deposited by means of a sputtering method. On the ITO, a resist material OFRP-800 (a product of Tokyo Ohka Kogyo Co., Ltd.) was applied and then patterned by means of a photolithography method, to obtain a transparent electrode 4 mm wide, 50 mm long, and 100 nm thick.

The substrate having the transparent electrode formed thereon was mounted in a resistance heating evaporation apparatus, and sequentially deposited without breaking the vacuum were a hole injection layer, a hole transport layer, a blue light emitting layer, a red light emitting layer, and an electron transport layer. The vacuum vessel for the deposition process was evacuated to 1×10⁻⁴ Pa. A hole injection layer was formed by depositing copper phthalocyanine (CuPc) to a thickness of 100 nm. A hole transport layer was formed by depositing 4,4′-bis[N-(1-natphty)-N-phenylamino]biphenyl (α-NPD) to a thickness of 20 nm. A blue light emitting layer was laminated to a thickness of 10 nm using a host material of DPVBi and a dopant of DPAVBi. The amount of added DPAVBi was 5 wt % with respect to the total weight of the blue light emitting layer. A red light emitting layer was laminated to a thickness of 30 nm using a host material of DPVBi and a dopant of DCM1. The amount of added DCM1 was 3 wt % with respect to the total weight of the red light emitting layer.

Then, without breaking the vacuum, Mg/Ag (in the weight ratio of 10/1) was deposited to obtain a reflective electrode 4 mm wide, 50 mm long and 200 nm thick.

Finally, the obtained laminate was transferred into a glove box with a dry nitrogen atmosphere (both oxygen concentration and moisture concentration were not more than 10 ppm) and sealed using a sealing glass and a UV-setting type adhesive. Thus, a light emitting device was obtained.

The obtained device was supplied with electric current and lighted, and white color light emission was obtained having a broad light emission distribution in the visible light region and a chromaticity of (x, y)=(0.28, 0.35) in the CIE XYZ color system.

### Example 2

A black matrix and color filters (red, green and blue colors) were deposited on a transparent glass substrate (1737 glass) using a black matrix material (CK-7001: a product of Fuji Film Arch Co., Ltd.), a red color filter material (CR-7001: a product of Fuji Film Arch Co., Ltd.), a green color filter material (CG-7001: a product of Fuji Film Arch Co., Ltd.), and a blue color filter material (CB-7001: a product of Fuji Film Arch Co., Ltd.). The green color filter was 2 μm thick, while other layers were 1 μm thick.

The color filters were formed so that a group of red, green and blue subpixels aligning transversely composed a pixel. Dimensions of each subpixel were longitudinally 300 μm and transversely 100 μm. A gap between adjacent subpixels was longitudinally 30 μm and transversely 10 μm. Consequently, the size of one pixel was longitudinally 300 μm and transversely 320 μm, and the gap between pixels was 30 μm in longitudinal direction and 10 μm in transverse direction. The pixels in this example were formed arranging 50 pixels in longitudinal direction and 50 pixels in transverse direction, summing up to total 2,500 pixels.

Then, a complementary color layer and a gas barrier layer were formed on the black matrix and the color filters in the same manner as in Example 1. A transparent electrode was formed on the gas barrier layer in the same manner as in Example 1 except that the configuration was changed to plural stripes each 100 μm wide and extending in the longitudinal direction with the gap of 10 μm between the stripes. Further in the same manner as in Example 1 formed were a hole injection layer, a hole transport layer, a blue light emitting layer, a red light emitting layer, and an electron transport layer. Then, a reflective electrode was formed using a mask in the same manner as in Example 1 except that the configuration was changed to plural stripes each 300 μm wide and extending in the transverse direction with the gap of 30 μm between the stripes. Finally, sealing was conducted in the same manner as in Example 1. Thus, a multicolor light emitting device was obtained.

All the pixels of the obtained multicolor light emitting device were lighted and chromaticity (x, y) in the CIE XYZ color system was measured on the emitted light. The result was white color light having a chromaticity of (x, y)=(0.28, 0.35). Then, each of groups of the red, green, and blue color subpixels was lighted supplying the same current as in the case of all pixel lighting, and measurement was conducted on the relative brightness (which means the proportion of brightness required for the colors of R, G, and B to give white light) as compared with the case of all pixel lighting, and the chromaticity (x, y) in the CIE XYZ color system. It has been demonstrated that sufficient amount of every color component is contained. The results of these measurements are given in Table 1.

TABLE 1
Evaluation results on the multicolor
light emitting device of Example 2

| | | | (CIE XYZ Color |
|---|---|---|---|
| | Relative | Chromaticity | System) |
| Lighted Part | Brightness | x | y |
| all pixels | — | 0.28 | 0.35 |
| red color subpixels | 27 | 0.62 | 0.36 |
| green color | 39 | 0.25 | 0.63 |
| subpixels | | | |
| blue color subpixels | 34 | 0.12 | 0.23 |

### Example 3

A multicolor light emitting device was obtained in the same manner as in Example 2 except that the host material of the red light emitting layer was changed to Alq₃ and the dopant was changed to DCM2.

All the pixels of the obtained multicolor light emitting device were lighted and chromaticity (x, y) in the CIE XYZ color system was measured on the emitted light. The result was white color light having a chromaticity of (x, y)=(0.30, 0.32). Then, each of groups of the red, green, and blue color subpixels was lighted supplying the same current as in the case of all pixel lighting, and measurement was conducted on the relative brightness as compared with the case of all pixel lighting, and the chromaticity (x, y) in the CIE XYZ color system. It has been demonstrated that sufficient amount of every color component is contained. The results of these measurements are given in Table 1.

TABLE 2
Evaluation results on the multicolor light emitting device of Example 3

| | | | (CIE XYZ Color |
|---|---|---|---|
| | Relative | Chromaticity | System) |
| Lighted Part | Brightness | x | y |
| all pixels | — | 0.30 | 0.32 |
| red color subpixels | 32 | 0.62 | 0.36 |
| green color subpixels | 28 | 0.25 | 0.63 |
| blue color subpixels | 40 | 0.12 | 0.23 |

### INDUSTRIAL APPLICABILITY

The present invention provides a partial structure of an electroluminescence element and a white or multicolor light emitting device including the partial structure which gives ideal white light emission containing all of the three wavelength regions of red, green and blue colors in a proper balance, and prevents variation of balance of light emission even in the cases of brightness change and continuous driving.

1. A light emitting device comprising:
a transparent substrate; and
a complementary color layer, a transparent electrode, an organic light emitting body, and a reflective electrode over the transparent substrate,
wherein the organic light emitting body includes at least a blue light emitting layer and a red light emitting layer,
wherein the complementary color layer is a single one-piece layer formed over one entire surface area of the organic light emitting body and formed between the transparent substrate and the organic light emitting body, absorbs part of light from the organic light emitting body and emits green color light, and transmits part of light from the organic light emitting body, and
wherein white light is obtained from the transparent substrate side of the complementary color layer.

2. The light emitting device according to claim 1, further comprising three types of color filters independently arranged between the transparent substrate and the complementary color layer, wherein multicolor light is obtained from white color emitted from the complementary color layer.

3. The light emitting device according to claim 2, wherein the complementary color layer further functions as a protective layer for the color filters.

4. The light emitting device according to claim 3, wherein the transparent electrode is composed of a plurality of electrode elements with a configuration of stripes extending in a first direction, and the reflective electrode is composed of a plurality of electrode elements with a configuration of stripes extending in a second direction, the first direction intersecting the second direction.

5. The light emitting device according to claim 3, wherein the transparent electrode is a single piece, and the reflective electrode is composed of a plurality of electrode elements each connecting to one of a plurality of switching elements.

6. The light emitting device according to claim 1, wherein the complementary color layer includes a matrix and at least one type of color conversion material dispersed in the matrix.

7. A method of producing a light emitting device comprising the steps of:
providing a transparent substrate; and
providing a complementary color layer, providing a transparent electrode, providing an organic light emitting body, and providing a reflective electrode in this order over the transparent substrate.

8. The method of producing a light emitting device according to claim 7, further comprising the step of independently providing at least three types of color filters before the step of providing the complementary color layer.

9. The method of producing a light emitting device according to claim 7, further comprising the step of providing a gas barrier layer before the step of providing the transparent electrode.

10. A light emitting device comprising:
a transparent substrate;
a filter laminate including at least a complementary color layer on the transparent substrate;
a device substrate; and
an organic light emitting element including a reflective electrode, an organic light emitting body, and a transparent electrode on the device substrate in this order,
wherein the filter laminate and the organic light emitting element are bonded together,
wherein the complementary color layer and the transparent electrode are disposed opposing each other, and
wherein white light is emitted from the transparent substrate side.

11. The light emitting device according to claim 10, further comprising three types of color filters independently arranged between the transparent substrate and the complementary color layer, wherein multicolor light is also emitted from the transparent substrate side.

12. The light emitting device according to claim 11, wherein the complementary color layer further functions as a protective layer for the color filters.

13. The light emitting device according to claim 12, wherein the transparent electrode is composed of a plurality of electrode elements with a configuration of stripes extending in a first direction, and the reflective electrode is composed of a plurality of electrode elements with a configuration of stripes extending in a second direction, the first direction intersecting the second direction.

14. The light emitting device according to claim 12 wherein the transparent electrode is a single piece, and the reflective electrode is composed of a plurality of electrode elements each connecting to one of a plurality of switching elements.

15. The light emitting device according to claim 10, wherein the complementary color layer includes a matrix and at least one type of color conversion material dispersed in the matrix.

16. A method of producing a light emitting device comprising the steps of:
providing a transparent substrate;
forming a filter laminate by providing a complementary color layer on the transparent substrate;
providing a device substrate;
providing a reflective electrode on the device substrate;
providing an organic light emitting body on the reflective electrode;
providing a transparent electrode on the organic light emitting body to obtain an organic light emitting element and
bonding the filter laminate and the organic light emitting element with the complementary color layer and the transparent electrode opposing each other.

17. The method of producing a light emitting device according to claim 16, further comprising the step of independently providing at least three types of color filters before the step of providing the complementary color layer.

18. The method of producing a light emitting device according to claim 16, further comprising the step of providing a gas barrier layer after the step of providing the complementary color layer.
